(19) United States
(12) Patent Application Publication
(10) Pub. No.: US 2019/0041663 A1
(43) Pub. Date: Feb. 7, 2019

(54) A CONTACT LENS THAT PERMITS DISPLAY OF VIRTUAL VISUAL INFORMATION DIRECTLY INTO THE USER'S EYE

(71) Applicant: BENNY LABS EYEWEAR LTD, Ashkelon (IL)

(72) Inventor: Ben Zion Yitzhack GOLDSTEIN, Ashkelon (IL)

(21) Appl. No.: 16/072,050

(22) PCT Filed: Jan. 23, 2017
(86) PCT No.: PCT/IL2017/050084

§ 371 Date: Jul. 23, 2018

Related U.S. Application Data
(60) Provisional application No. 62/287,154, filed on Jan. 26, 2016.

(51) Int. Cl. G02C 7/04; G02B 27/01; G02C 11/00

(52) U.S. Cl. CPC G02C 7/04; G02B 2027/0178; G02C 11/10; G02B 27/0172

(57) ABSTRACT

The present invention relates to system for displaying content from a content provider to the user's field of view comprising: (a) at least one display for displaying said content; (b) communication means for communicative association with said content provider; and (c) at least one contact lens with reflective means for reflecting said content from said display to said user's field of view; wherein said lens is placed directly on the surface of the eye of said user.

### TECHNICAL FIELD

The present invention relates to optical device accessories. More particularly, the present invention relates to a contact lens that permits display of virtual visual information directly into the user's eye.

### BACKGROUND

Over the past several years, numerous methods, systems and components have been developed that project and display visual information from mobile electronic devices into the visual fields of their user, such as wearable display glasses. Such wearable objects would permit the user to view the information without looking away from the surrounding environment. Display systems of this kind are often referred to as “Personal HUD” or “Wearable HUD” (where HUD stands for Heads Up Display) For the most part, Personal HUD devices resemble eye glasses. The ultimate goal of these systems is to project into the user's view information, from sources of electronic devices, which show up in different peripheral corners of his visual field, while leaving the visual field free of obfuscation.

US 2007/064311 discloses a head mounted display system. The described head mounted display system includes a frame where the frame is coupled to the head of a user. A projector head is coupled to the frame where the projector head provides an image. A screen is also coupled to the frame where the screen displays an image to the user. A mirror is also coupled to the frame, where the mirror reflects the image provided by the projector head onto the screen. However, the described system is heavy and uncomfortable.

US 2012/212400 discloses a see-through near-eye display glasses including a curved polarizing film in the image source, a partially reflective, partially transmitting optical element and an optically flat film. The described interactive head-mounted eyepiece has an integrated processor, for handling content for display, and an integrated image source, for introducing the content to an optical assembly, through which the user views a surrounding environment. The displayed content is directed as light beams to a curved polarizing film of the optical assembly that reflects a portion of the light to illuminate a reflective image display. The optical assembly comprises an optically flat film that reflects the image light from the reflective image display to a curved partially reflecting mirror that reflects a portion of the image light and transmits a portion of the scene light from a see-through view of the surrounding environment, so that a combined image comprised of portions of the reflected image light and the transmitted scene light is transmitted through the optically flat film and provided to the user's eye. Nevertheless, the described system is costly.

WO 2016/110831 and WO 2016/038615, both of which are incorporated herein by reference, also disclose a wearable apparatus, resembling eye glasses, which can display content from a content provider to the user's view.

It would therefore be desired to propose a system void of these deficiencies.

### SUMMARY

It is an object of the present invention to provide a system for hands free view from a content provider.

It is another object of the present invention to provide a contact lens that permits display of virtual visual information directly into the users view.

It is still another object of the present invention to provide a wearable system which can display content on the user's view without substantially obstructing the user's view.

Other objects and advantages of the invention will become apparent as the description proceeds.

The present invention relates to system for displaying content from a content provider to the user's field of view comprising: (a) at least one display for displaying said content; (b) communication means for communicative association with said content provider; and (c) at least one contact lens with reflective means for reflecting said content from said display to said user's field of view; wherein said lens is placed directly on the surface of the eye of said user.

Preferably, the display is adjustable to fit the user's view.

Preferably, the reflective means comprise magnifying capabilities.

In one embodiment, the reflective means are a prism.

In one embodiment, the prism comprises means for magnifying the displayed content.

In one embodiment, the reflective means have a concave shape.

In one embodiment, the reflective means are a lens.

In one embodiment, the content is textual content.

Preferably, the system comprises a sound output device.

Preferably, the system comprises an input device.

In one embodiment, the contact lens is a corrective lens.

In one embodiment, the display is a circular display strip.

In one embodiment, the reflective means are a round circular reflection surface.

In one embodiment, the reflective means are a central reflection surface and a round circular reflection surface around said central reflection surface.

In one embodiment, the reflective means comprise a number of reflective surfaces which correspond together to the display as to reflect together, to the user's eye, an image from said display.

The present invention may also relate to a method for displaying content from a content provider to the user's field of view comprising: (a) communicating said content from said content provider; (b) displaying said content, on a display, from said content provider; and (c) providing at least one contact lens with reflective means for reflecting said content from said display to said user's field of view; wherein said contact lens is placed directly on the surface of the eye of said user.

Preferably the method further provides at least one crystalline refractive structure, capable of reflecting light, for displaying a beacon of light in the user's peripheral vision area.

In one embodiment, the movement of the eye of the user changes the displayed content accordingly.

### BRIEF DESCRIPTION OF THE DRAWINGS

The drawings and descriptions are meant to illuminate and clarify embodiments disclosed herein, and should not be considered limiting in any way.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

In the drawings:

FIG. 1 is a side view of a display and the contact lens, on the eye of a user, with an embedded reflective surface, according to an embodiment of the invention.

FIG. 2 is an example drawing of a curved reflective surface before it is embedded in a contact lens, according to an embodiment of the invention.

FIG. 3 is a side view of a display and the contact lens, with an embedded prism acting as a reflective surface, according to an embodiment of the invention.

FIG. 4 is a side view of a display and the contact lens, with another embedded prism acting as a reflective surface, according to an embodiment of the invention.

FIG. 5 is a side view of a display and the contact lens, with an embedded prism and lenses, according to an embodiment of the invention.

FIG. 6A is a side view of a display and the contact lens, with an embedded lens acting as a reflective surface, according to an embodiment of the invention.

FIG. 6B is a front view of a display and the contact lens, where the display is position under the eye of the user, according to an embodiment of the invention.

FIG. 7 is a front view of a display and the contact lens, according to an embodiment of the invention.

FIG. 8 is a front view of a number of displays and the contact lens, according to an embodiment of the invention.

FIG. 9 is a view from the user's point of view, having of a number of displays, and the contact lens, according to an embodiment of the invention.

FIG. 10 is another view from the user's point of view having a number of displays and the contact lens, according to another embodiment of the invention.

FIG. 11 is yet another view from the user's point of view having a number of displays and the contact lens, according to yet another embodiment of the invention.

FIG. 12 is a front view of an overhead display which comprises a number of displays, according to an embodiment of the invention.

FIG. 13 depicts diagrams of a number of lenses, according to embodiments of the invention.

FIG. 14 is a side view of an array of displays around the eye of a user, according to an embodiment of the invention.

FIG. 15 is a side view of an array of displays, around the eye of a user, and a contact lens, with an embedded reflective surface, according to an embodiment of the invention.

FIG. 16 is a front view of a larger display and a contact lens, according to an embodiment of the invention.

### DETAILED DESCRIPTION

The terms of “front”, “rear”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

FIG. 1 is a side view of a display and the contact lens, on the eye of a user, with an embedded reflective surface, according to an embodiment of the invention. The depicted Wearable HUD (Heads Up Display) system has a display 100 for displaying content from a content provider. In one embodiment, the display 100 may be embedded in a frame worn over the eyes of the user, effectively positioning the display 100 in the peripherally of the eye of the user. The display 100 may be an LCD display or any other display capable of displaying and/or projecting content. The content may be letters, words, pictures, images, videos or any other visual content provided by a content provider. The content provider may be a Smartphone, Tablet, computer, server, or any electronic apparatus which can provide and communicate content. The display 100 may be in communicative association with a content provider using any known communication means, wired or wireless communication method, such as Bluetooth, Wi-Fi, cellular network, NFC, etc. The display 100 may project content to the reflective surface 200, on the contact lens 210, which may be arranged to reflect the content to the user's eye 300. Thus a user may, for example, communicatively connect the described HUD system to his smartphone using Bluetooth for displaying content from his smartphone to his eye. For example, the user may walk on the street while reading text messages received on his smartphone.

The contact lens 210 may be any known thin lens, soft or rigid or Hybrid, placed on the surface of the eye. The contact lens 210 may also be used as a corrective lens, cosmetic lens, therapeutic lens, or for any other known contact lens use. The lens 210 may be made of PHEMA, PMMA, Silicon hydrogel or any other known material used for making contact lens. In one embodiment, the lens 210 diameter may have a size of between 11-13 mm. In one embodiment, the lens 210 diameter may have a size of between 9-15 mm. In one embodiment, the lens diameter may have a size of between 7-17 mm. In one embodiment, the contact lens 210 width may be set to include +/−2.5 diopters. In one embodiment, the contact lens 210 width may be set to include +/−3.5 diopters. In one embodiment, the contact lens 210 width may be set to include +/−6.5 diopters. In one embodiment, the lens 210 may have an antireflective cover. In one embodiment the antireflective cover may also be used as mirror for reflecting some of the light beams. In one embodiment, the lens 210 may have a scratch-resisting coating. In one embodiment, the lens 210 may have an anti-fog coating. In one embodiment, the lens 210 may have an ultraviolet treatment. In one embodiment, the lens 210 is placed directly on the surface of the eye of the user.

In one embodiment, the contact lens 210 may be soft and may be slightly thicker than usual in order to accommodate the extra width of the curved reflective surface. The reflective surface may be located about the center of the pupil, and it is angled upward to reflect and focus a tiny image into the pupil itself. In one embodiment, the curved reflective surface may be reflective only on the inside, so when it is not reflecting an image of some sort, it may be nearly invisible to the user. In one embodiment, the reflective surface may be an optical device, similar to a magnification mirror, with a curved concave shape which precisely focuses the image projected by the screen for the user.

In one embodiment, the screen of display 100 can be adjusted, manually or automatically, to correspond with the reflecting surface 200 of the contact lens 210. In one embodiment, the overall displaying surface of display 100 is intentionally larger than the content, intended for display, so as to allow space for special adjustment of the image in the display 100.

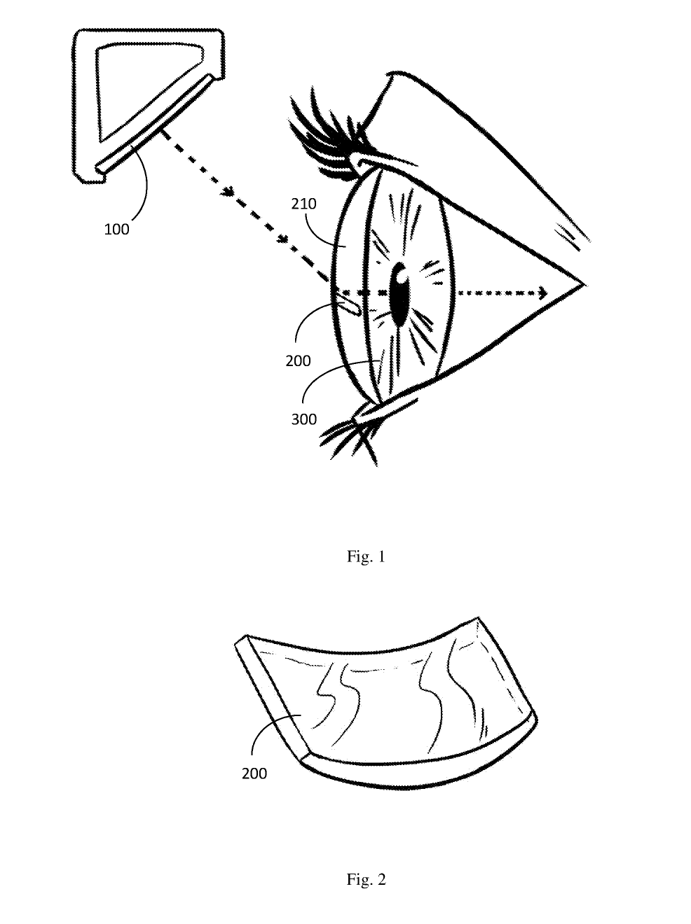

FIG. 2 is an example drawing of a curved reflective surface before it is embedded in a contact lens, according to an embodiment of the invention. As described, in relations to FIG. 1, the contact lens may have reflective means, such as the reflective surface 200, for reflecting the content from the display to the user's field of view. In one embodiment the reflective means are made of plastic material which is glued on a lens using one of the known optical adhesives. In one embodiment the reflective means is actually a prism which bends the light beams from the display into the eye of the user. In some case the reflecting means are positioned as to reflect the light from the display into the macula in the eye of the user.

In some embodiments, the reflective optic component may be transparent or semitransparent in order to allow the user to see through the reflective surface, when not directly viewing the visual content. Hence, the user may see both the displayed content, in front of his view, as well as his regular view.

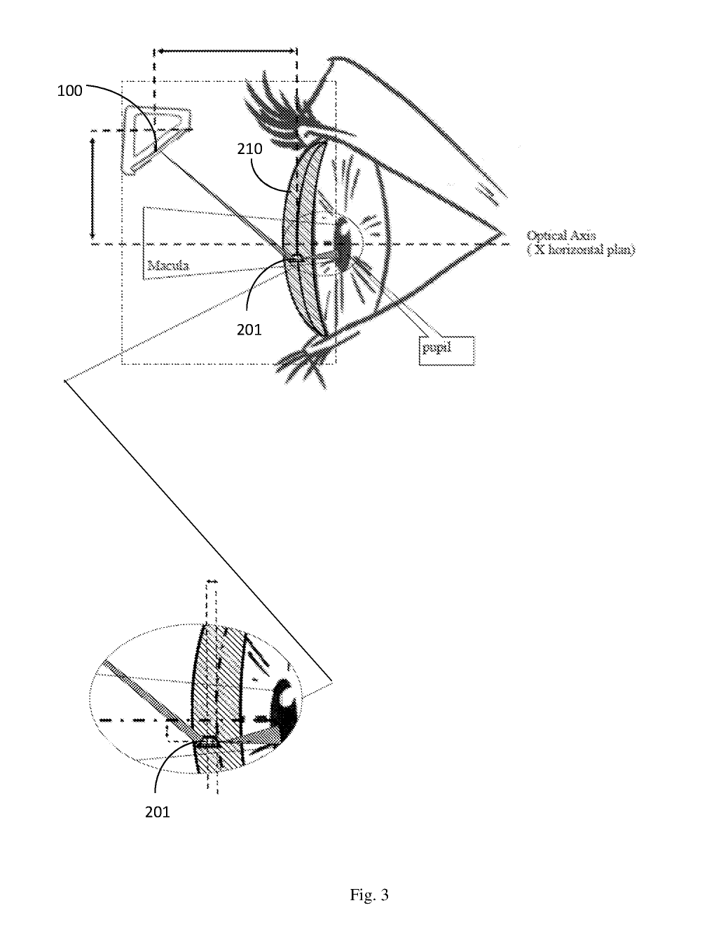

FIG. 3 is a side view of a display and the contact lens, with an embedded prism acting as a reflective surface, according to an embodiment of the invention. In an embodiment, the prism 201 may be located on the lens 210 as to specifically bend the light beams from the display 100 to the macula in the eye of the user. In one embodiment the prism 201 is in the shape of a trapezoid for effectively bending the light beams from the display 100 into the eye of the user. The prism 201 may be located in any number of places on the lens, may have different lengths and sizes, and may have a number of angles and shapes according to various embodiments and according to the preferred content display to the eye of the user. For example, the prism may be used for projecting the content to the lower part of the pupil as to keep the user's main viewing or eye-gaze direction substantially or at least largely unobstructed.

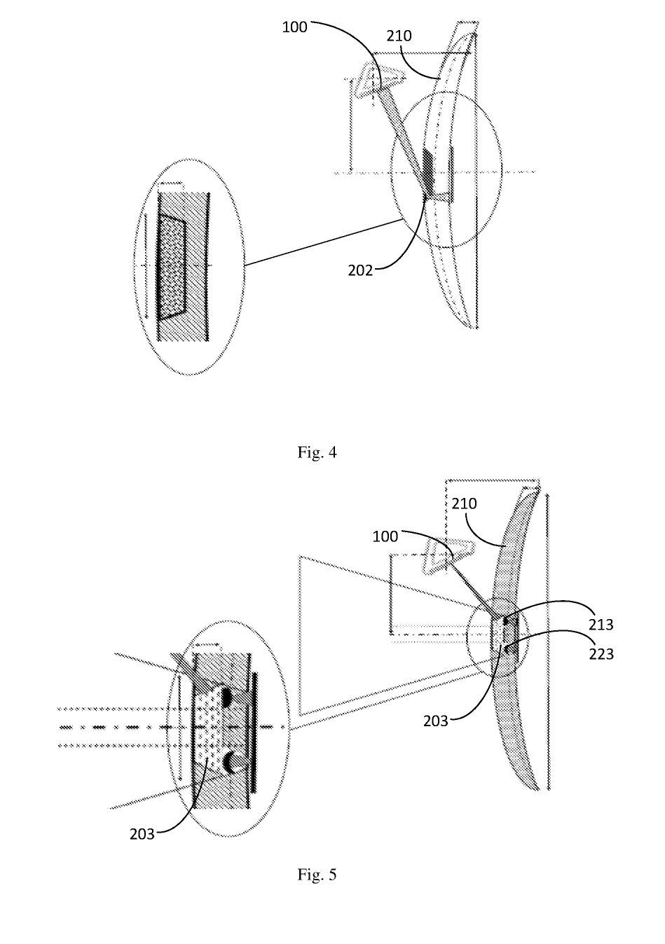

FIG. 4 is a side view of a display and the contact lens, with another embedded prism acting as a reflective surface, according to an embodiment of the invention. In this embodiment, the prism 202 may be positioned vertically on the lens 210 for bending the light beams from the display 100 to the eye of the user. In one embodiment the prism 202 is in the shape of a trapezoid for effectively bending the light beams from the display 100 into the eye of the user. The prism 202 may be located in any number of places on the lens, may have different lengths and sizes, and may have a number of angles and shapes according to various embodiments and according to the preferred content display to the eye of the user.

FIG. 5 is a side view of a display and the contact lens, with an embedded prism and lenses, according to an embodiment of the invention. In this embodiment, the prism 203 may be positioned vertically on the lens 210 and another smaller lens 213 may be positioned on the prism 213 for bending the light beams from the display 100 to the eye of the user and/or for magnifying the content for the user. In one embodiment the prism 203 is in the shape of a trapezoid and the lens 213 can be a plano-convex type lens or any other type lens. In one embodiment a lens 223 may be added as well to the prism 203 and the lens 223 can be a plano-concave type lens or any other type lens. The prism 203, and the lenses 213 and 223, may be located in any number of places on the lens 210, may have different lengths and sizes or focal points, and may have a number of angles and shapes according to various embodiments and according to the preferred content display to the eye of the user.

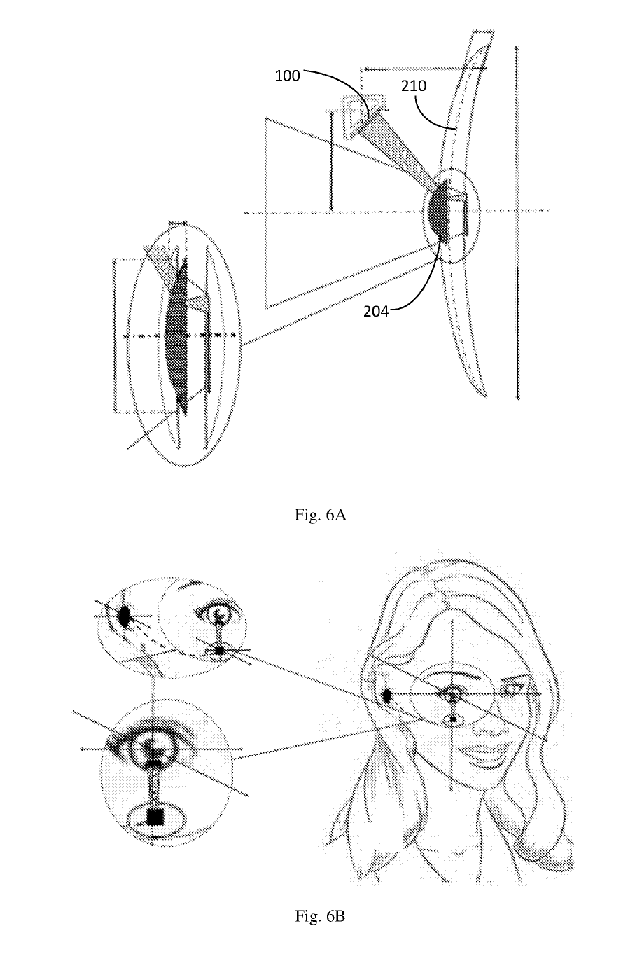

FIG. 6A is a side view of a display and the contact lens, with an embedded lens acting as a reflective surface, according to an embodiment of the invention. In this embodiment, the reflecting lens 204 may be located on the contact lens 210 as to bend the light beams from the display 100 to the eye of the user. In one embodiment the reflecting lens 204 may be a positive meniscus lens with a convex-concave shape for bending the light beams from the display 100 into the eye of the user. The reflecting lens 204 may be located in any number of places on the contact lens 210, may have different widths and sizes, according to various embodiments and according to the preferred content display to the eye of the user. 3. In some embodiments, the reflective means of the contact lens 210 may also have magnifying capabilities which can magnify the content received from the display 100.

FIG. 6B is a front view of a display and the contact lens, where the display is position under the eye of the user, according to an embodiment of the invention. In this embodiment the display is positioned under the eye of the user and the display may reflect the light beams to a lens with a reflecting surface from the bottom.

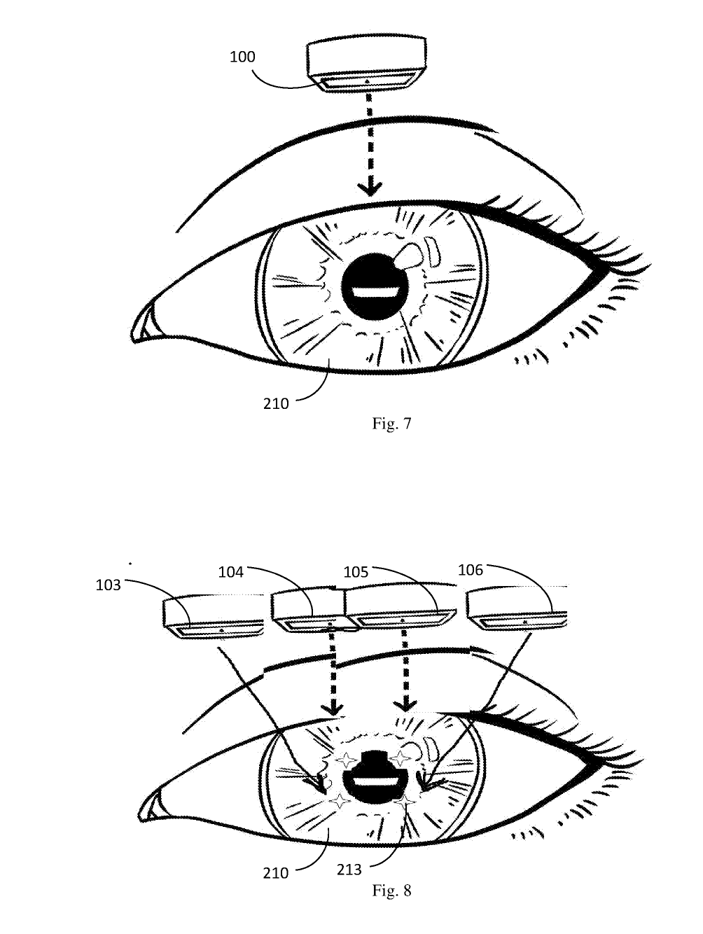

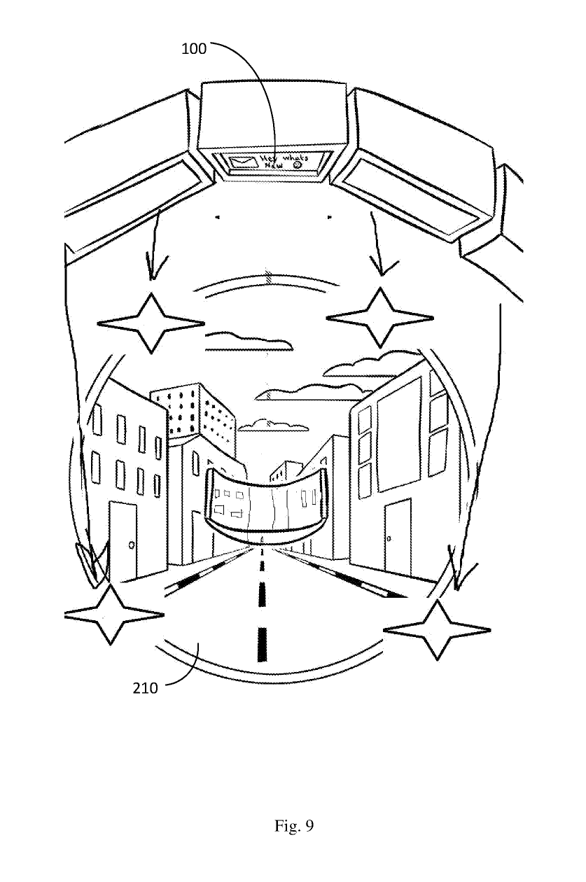

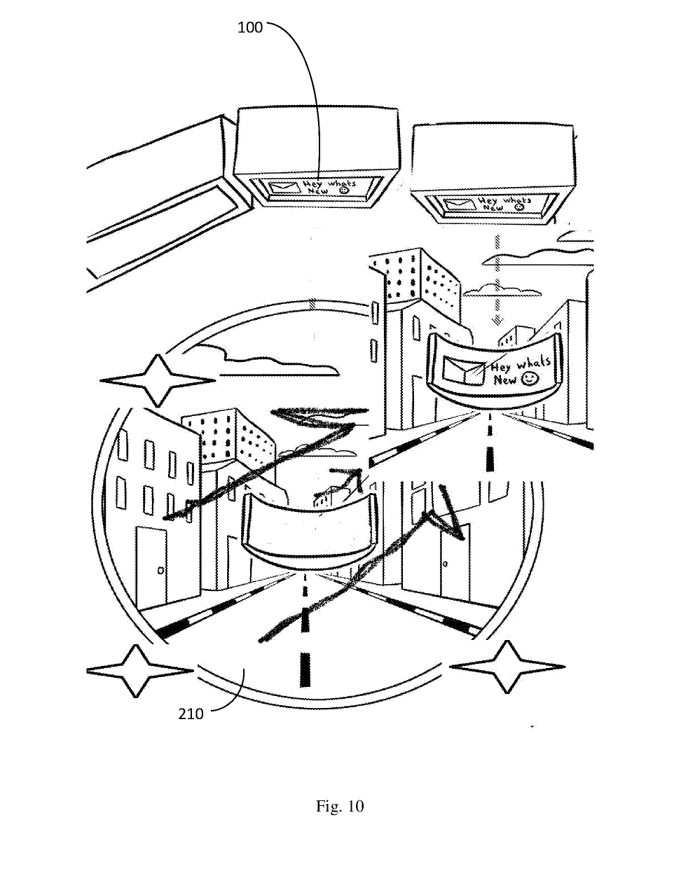

FIG. 7 is a front view of a display and the contact lens, according to an embodiment of the invention. The method and system disclosed above effectively makes the HUD experience realizable within the tiny dimensions of a contact lens. The described HUD system may comprise 3 interacting components: 1) the contact lens 210, 2) the overhead display 100 and 3) the content provider such as the user's smartphone (not shown). As described above, the contact lens 210 may contain a tiny, thin surface which reflects and focuses the images from the overhead display's screens into the user's eye. In actuality, it is the overhead display 100 which presents the visual information above the user's eye, allowing it to be reflected into user's visual field. The Overhead Display 100, in turn, receives the visual information from the user's smartphone. In one embodiment, The contact lens 210 comprises the insertion of a tiny, very thin, curved reflective surface into the substance of a contact lens, as shown in FIGS. 1-7.

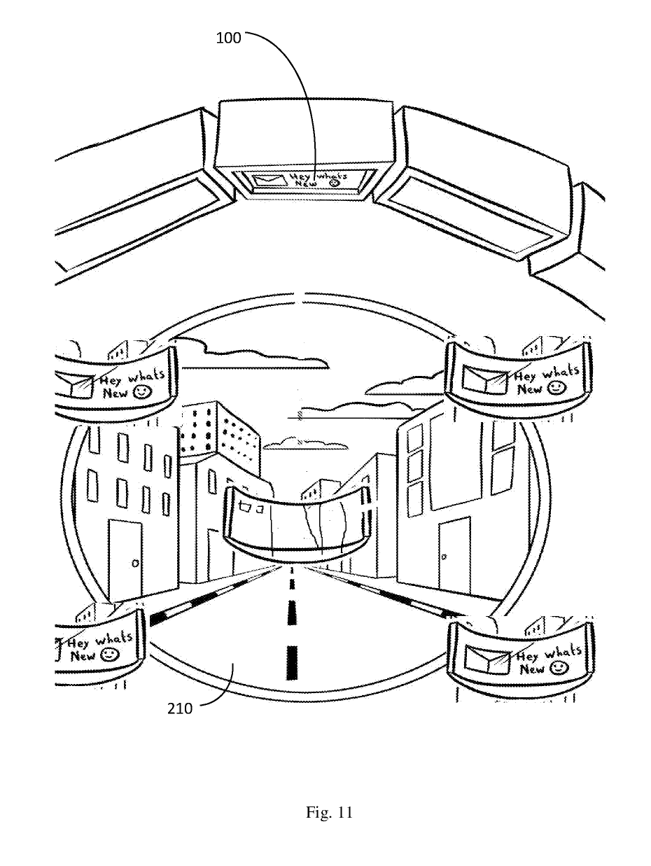

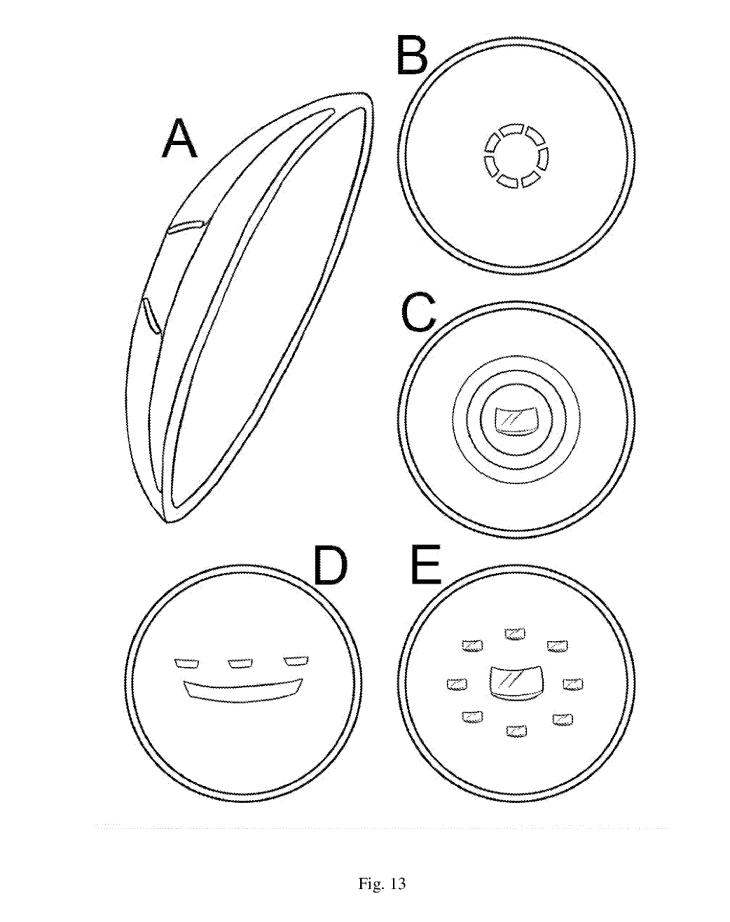

FIG. 8 is a front view of a number of displays and the contact lens, according to an embodiment of the invention. FIGS. 9-12 are views from the user's point of view having of a number of displays and the contact lens, according to embodiments of the invention. In an embodiment, a number of displays may be added to the HUD system, for displaying content, such as the displays 103-106. In one embodiment, a number of reflective surfaces may be inserted into the lens 210 at cardinal positions (up/down/left/right) in the periphery area for corresponding with the displays 103-106. For example, there may be small crystalline refractive structures capable only of reflecting light diffusely such as refractive structure 213. For example, at such time as some visual information becomes available (for instance when a phone call is received by the user's smartphone) a notification will shine in an overhead screen in an area corresponding to one of the crystals. This will result in a beacon of light appearing in the user's peripheral vision area. From the user's point of view, this light beacon corresponds to the location where the information carrying image will subsequently appear, as depicted in FIG. 9. Thus, the movement of the eye of the user may change the displayed content accordingly. For example, if the eye of the user moves towards the crystal displaying a notification, from the users email box, then the information on the center reflective surface may change to show the email box. In one embodiment, in order for the input to be projected properly, configurations of small screens are used to present the content each at a precise angle, as depicted in FIG. 11. In one embodiment, the display is one circular display strip. In one embodiment, the display is one wide circular display strip which may be positioned around the eye of the user and the displayed content may be easily calibrated to correspond with the reflective surface.

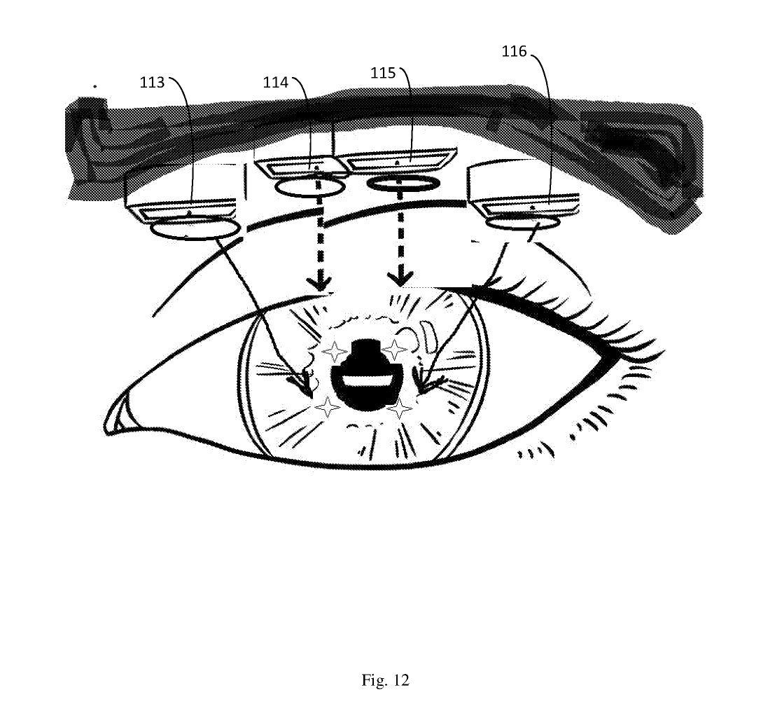

When the user moves his pupil in the direction of the notification beacon, the reflective surface encounters the image, and relays it into the user's pupil. When the user returns his view to the scene straight ahead, the image will disappear (since it will no longer be reflected) but it will be represented by the peripheral light beacon. Thus the visual input will be visible to the user only when he/she looks at it directly, as depicted in FIG. 10. In some embodiments, the contact lens 210 along with the overhead display is able to display visual content in several locations relative to the center of the user's visual field: This includes (but is not necessarily limited to) 1) upper right 2) upper left 3) lower right and 4) lower left. Once again, the specific content being displayed is only truly visible when the user moves his eye to look at it. At other times, the notification light beacon (generated by the interaction of the displayed image and the peripheral crystal) replaces the complete image as depicted in FIG. 11.

FIG. 12 is a front view of an overhead display which comprises a number of displays, according to an embodiment of the invention. In this embodiment, a number of several high definition display screens, or a single larger curved screen that can display multiple feeds at once, are located some distance above the user's eye. Taken together they may resemble a row of attached computer chips, and be supported by an eyeglass-type construction, worn on the ears and nose, without any lenses. In one embodiment, plain, sun or prescription lenses can be added to the construction. The display screens are designed to fit over the user's eye to display visual input in a downwards direction. In the drawing there are four display screens right next to each other, where the images, from the displays 113 and 116, are meant to be viewed in the lower visual positions (lower right and lower left) are displayed on the two outermost screens the far sides of the screen, and the images viewed in the upper positions are displayed in the two center displays 114-115. Each position of the screen may have a powerful magnifying lens to contract the image so as fit fits completely into the reflective surface. The lenses may also angle the images, so the side images display at a more inward facing angle, so they will be visible in the lower/right and lower/left positions. The two middle lenses may contract their images and display them straight down so the images appear in the upper/right and upper left positions.

In one embodiment, the overhead display may be fitted with a small microphone for receiving voice input from the user, and/or an ear piece for receiving audio information. Commands and menu selections are conveyed by voice commands. The overhead display device may also contain a touch sensitive area to allow menu selection by way of tapping on the side of the device, for example.

An application may be required to adapt the input from the content provider so it can be adequately displayed by the overhead display device and reflected by the contact lens. The various input streams may be routed to each of the display screens as per the user's preferences.

In an example, Bluetooth technology will be used to transmit visual and audial information from the smartphone to the overhead display, and a special application for adapting the smartphone input and conveying commands or selections may be downloaded to the smartphone.

In some cases the wearable HUD system may be operative to receive data descriptive of the content to be displayed by the viewing optics as an image from an external information provider system, e.g., via a communication network. In one example the user may connect the wearable HUD system to a remote server, using a cellular network for example, for displaying content to his eye from the Internet.

In one embodiment, the contact lens 210 may be surgically attached to the user's eye. In one embodiment, the reflective surface may be surgically attached to the user's eye. In one embodiment, the reflective surface may be surgically molded to the user's natural eye lens, to bend the light beam from the display into the eye.

FIG. 13 depicts diagrams of a number of lenses, according to embodiments of the invention. Lens A in FIG. 13 depicts a lens with upper and lower reflectivity for presenting simultaneous streams of visual input. It is possible to arrange two reflective surfaces, one in an upper position relative to the pupil and the second in the standard lower position. In this way the user will be able to receive visual input in one of two positions relative to the center of his/her visual field, even simultaneously. When two objects appear simultaneously, the viewer may typically shift his eye from one object to the other. In the embodiment, the reflective surface may be slightly off the center of the visual field. In one embodiment, the user may move his eye and the reflective surface into position for viewing the information from the display 100. In another embodiment, the user may be able to observe two images simultaneously without actually shifting his eye from one object to the other, since both reflective surfaces may be near the center of the visual field and the user's brain may be able to shift attention between one image and the other. In one embodiment the reflective surfaces may be transparent to the user, when they are not receiving visual streams. The display may be positioned and calibrated accordingly with both reflective surfaces.

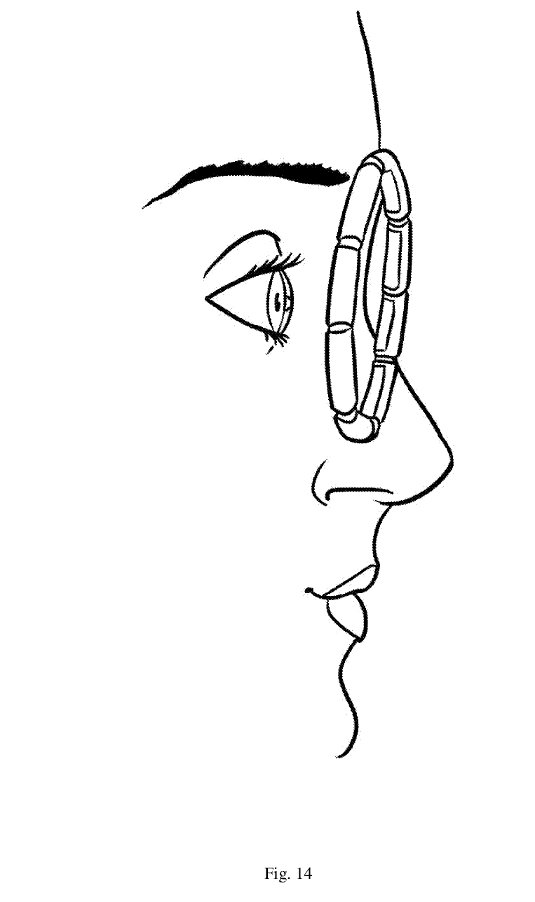

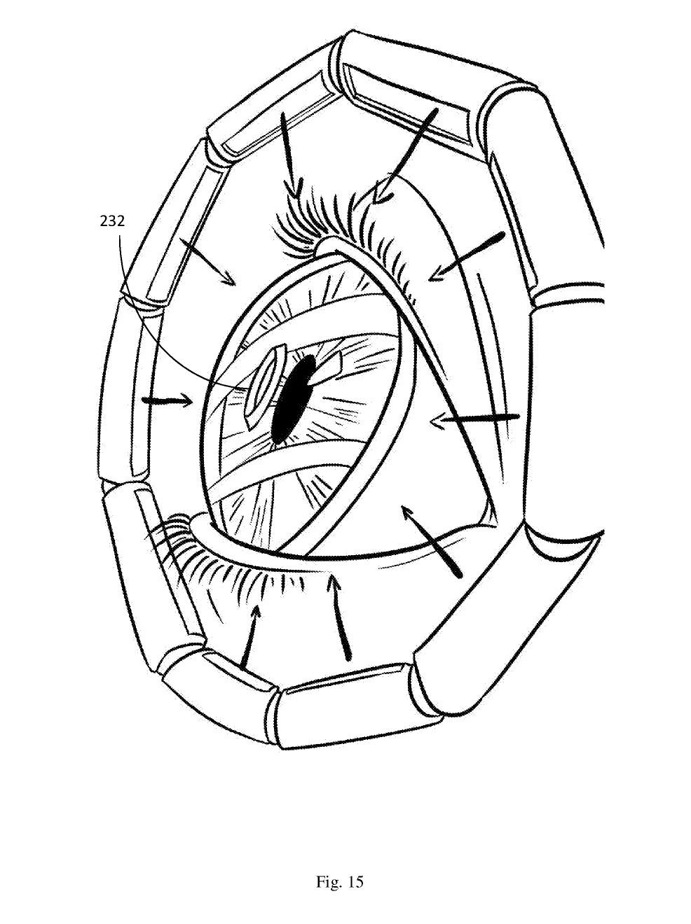

Lens B in FIG. 13 depicts a lens with circular array of reflective surfaces, according to an embodiment of the invention. In this embodiment, the user may be able to see seven or more different visual input streams simultaneously. In this embodiment, the array of the display screens may be arranged in a circular configuration around the eye, each screen calibrated so the light it emits is reflected on the corresponding reflective surface inside the contact lens such as depicted in FIG. 14. In another embodiment, a single continuous circular high definition display screen may be used which can permit even greater flexibility and fluidity in how the visual input is displayed. The circular display screen may be mounted on a construction similar to that of a pair of eyeglasses, and may surround the eye from all directions, projecting the images inward at an angle so the multiple reflective surfaces in the contact lens will reflect them into the pupil. Thus, each stream of visual input will necessarily appear in that reflective surface that is especially angled to receive this input; for instance, the visual stream from the far left screen will be reflected by the far right reflective surface, while the lower most screen will be reflected by the upper most reflective surface.

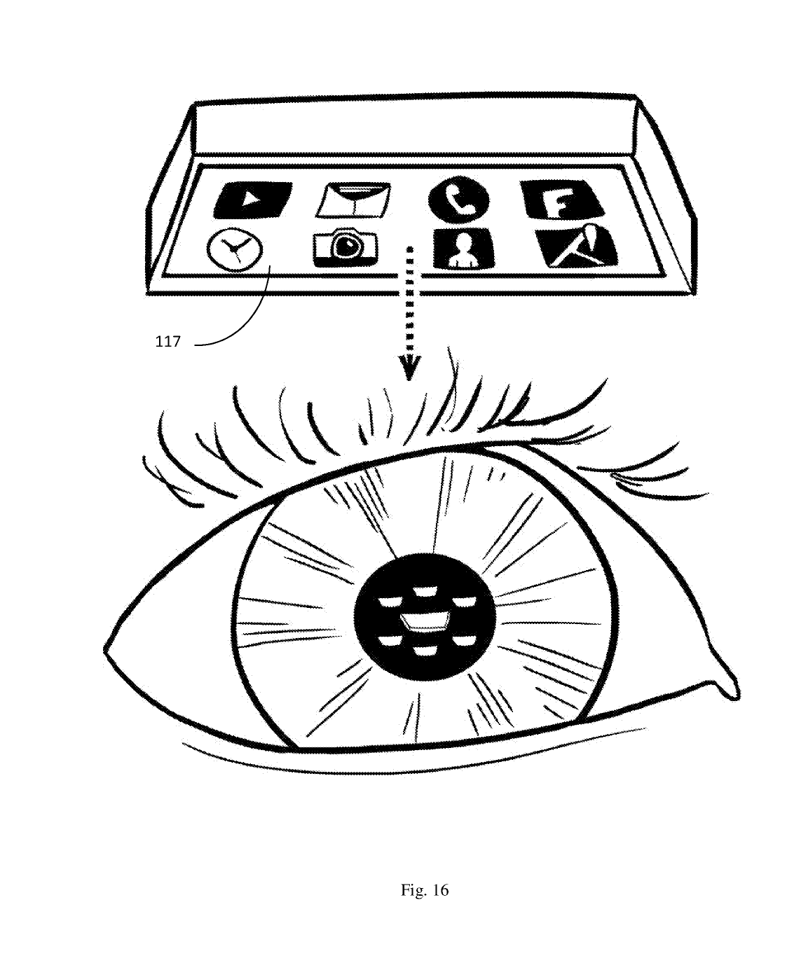

Lens C in FIG. 13 depicts a lens with one or more rings, of a refractive substance, added to more easily pick up the notifications of incoming visual streams, according to an embodiment. Instead of a mere shining light the refractive rings may provide the user with a rainbow like blaze of color in the position where the input will appear. Then the user can move his eye (and the reflective surface) to look at the spot where the visual input will appear. The use of refractive rings in the contact lens will make it easier for the display screens to direct their light at the proper position, since the rings are continuous and not discrete. In this embodiment, the display screens do not need to be so precisely aligned. This may allow greater freedom in designing the supporting construction which will house the display screens. This may allow the overall display unit to have a more free-flowing and fashionable design. In another embodiment, multiple reflective surfaces can be arranged in a cone shape which will allow input to be streamed from all angles. In one embodiment, lens C may have only one refractive ring, as depicted, for example, in FIG. 15 as ring 232. In one embodiment, lens C may have only one refractive ring with a reflective surface at the center piece.

Lens D in FIG. 13 depicts a lens with multiple small reflective surfaces surrounding the main reflective surface to allow for receiving notifications or menu selection, according to an embodiment. In this embodiment, the user may be able to identify simple icons in their peripheral vision and use them to identify the sources of incoming visual input, or to use such icons for choosing options in a menu. The contact lens D depicted in FIG. 13 may also contain a single long reflective surface for displaying the visual input to the user's eye. The long reflective surface will make it possible for the user to read lines of text by moving the reflective surface over the position where the visual input appears. The contact lens may also contain more than one tiny reflective surfaces where notifications or menu items may appear as simple icons in the periphery of the visual field. In this embodiment, the display(s) may require an appropriate configuration as to show icons and the content from the display.

Lens E in FIG. 13 depicts a lens with an array of small reflective surfaces surrounding the main reflective surface, according to an embodiment. In this embodiment, a number of tiny reflective surfaces may be located in the peripheral positions of the lens. This may serve to increase the number of icons that could be presented in the periphery of the user's visual field. The primary purpose of this array is to provide a larger number of options for the user to choose from. In this embodiment, the display(s) may require an appropriate configuration to show icons and the content from the display.

FIG. 14 is a side view of an array of displays around the eye of a user, according to an embodiment of the invention. In this embodiment, the array of the display screens may be arranged in a circular configuration around the eye, each screen calibrated so the light it emits is reflected on the corresponding reflective surface inside the contact lens such as Lens B depicted in FIG. 13.

FIG. 15 is a side view of an array of displays, around the eye of a user, and a contact lens, with an embedded reflective surface, according to an embodiment of the invention. In this embodiment, the reflective surface 232 may be a round reflective surface for reflecting content from the displays around the eye. In one embodiment, the depicted contact lens may also have a reflective surface at its center as well.

FIG. 16 is a front view of a larger display and a contact lens, according to an embodiment of the invention. In this embodiment, a single wide curved screen 117 can be utilized to show content, various icons, or simultaneous visual content streams on a contact lens such as lens E depicted in FIG. 13.

The described system may have an input device such as a wheel input element or knob, and/or by a touch sensitive surface (e.g., touch screen) for enabling a user to control the speed of the scrolling of the content displayed to him/her. Input device may for example be used to speed up, slow down or even reverse the scrolling of content, depending on the speed and direction of rotation of the wheel input element, displayed to the user.

In one embodiment, the reflective means may comprise a number of reflective surfaces on the contact lens which correspond together to a single display. In this embodiment, the reflective surfaces may be spaced apart and may each have a certain angel as to reflect together, to the user's eye, one image from the display, although each reflective surface reflects only a part of the image. For example, if a display displays an image to the reflective surfaces, each of the reflective surfaces may reflect only a part of the image, however, when the image parts are reflected to the eye of the user they are received as one image as all the image parts are meshed together to one image in the eye of the user.

While the above description discloses many embodiments and specifications of the invention, these were described by way of illustration and should not be construed as limitations on the scope of the invention. The described invention may be carried into practice with many modifications which are within the scope of the appended claims.

1. A system for displaying content from a content provider to the user's field of view comprising:
at least one display for displaying said content;
communication means for communicative association with said content provider; and
at least one contact lens with reflective means for reflecting said content from said display to said user's field of view;
wherein said lens is placed directly on the surface of the eye of said user.

2. A system according to claim 1, where the display is adjustable to fit the user's view.

3. A system according to claim 1, where the reflective means comprise magnifying capabilities.

4. A wearable apparatus according to claim 1, where the reflective means are a prism.

5. A wearable apparatus according to claim 4, where the prism comprises means for magnifying the displayed content.

6. A wearable apparatus according to claim 1, where the reflective means have a concave shape.

7. A wearable apparatus according to claim 1, where the reflective means are a lens.

8. A wearable apparatus according to claim 1, where the content is textual content.

9. A system according to claim 1, comprising a sound output device.

10. A system according to claim 1, comprising an input device.

11. A wearable apparatus according to claim 1, where the contact lens is a corrective lens.

12. A wearable apparatus according to claim 1, where the display is a circular display strip.

13. A wearable apparatus according to claim 1, where the reflective means are a round circular reflection surface.

14. A wearable apparatus according to claim 1, where the reflective means are a central reflection surface and a round circular reflection surface around said central reflection surface.

15. A wearable apparatus according to claim 1, where the reflective means comprise a number of reflective surfaces which correspond together to the display as to reflect together, to the user's eye, an image from said display.

16. A method for displaying content from a content provider to the user's field of view comprising:
communicating said content from said content provider;
displaying said content, on a display, from said content provider; and
providing at least one contact lens with reflective means for reflecting said content from said display to said user's field of view;
wherein said contact lens is placed directly on the surface of the eye of said user.

17. A method according to claim 16, further providing at least one crystalline refractive structure, capable of reflecting light, for displaying a beacon of light in the user's peripheral vision area.

18. A method according to claim 17, where the movement of the eye of the user changes the displayed content accordingly.
